(19) United States
(12) Patent Application Publication
(10) Pub. No.: US 2025/0131751 A1
(43) Pub. Date: Apr. 24, 2025

(54) GRAPHICAL USER INTERFACE FOR ARTIFICIAL INTELLIGENCE ANALYSIS OF IMAGING FLOW CYTOMETRY DATA

(71) Applicant: CYTEK BIOSCIENCES, INC., Fremont, CA (US)

(72) Inventors: Vidya Venkatachalam, Fremont, CA (US); Paula Glaus, Fremont, CA (US); Alan Yang Li, Fremont, CA (US)

(73) Assignee: CYTEK BIOSCIENCES, INC., Fremont, CA (US)

(21) Appl. No.: 18/751,184

(22) Filed: Jun. 21, 2024

Related U.S. Application Data
(63) Continuation-in-part of application No. 18/749,606, filed on Jun. 20, 2024.
(60) Provisional application No. 63/522,398, filed on Jun. 21, 2023.
(60) Provisional application No. 63/522,400, filed on Jun. 21, 2023.
(60) Provisional application No. 63/522,133, filed on Jun. 20, 2023.

(51) Int. Cl. G06V 20/69; G06F 9/451; G06V 10/764

(52) U.S. Cl. CPC G06V 20/698; G06F 9/453; G06V 10/764

(57) ABSTRACT

A user interface wizard generated by AI software walks a user through setting up an artificial intelligence (AI) image analysis experiments on multispectral cellular images using AI image analysis algorithms and AI feature analysis algorithms. In a training experiment mode, a new AI model a new AI model can be trained for a desired experiment on training image cellular data of biological cells in a sample and subsequently to run a classification experiment in a classification mode to classify new image cellular data of biological cells in the sample using the new AI model.

### COPYRIGHT/TRADEMARK NOTICE

A portion of the disclosure of this patent document contains material to which a claim for copyright and trademark is made. The copyright and trademark owner has no objection to the reproduction of the patent document or the patent disclosure, as it appears in the U.S. Patent Office records, but reserves all other copyright and trademark rights whatsoever.

### CROSS-REFERENCE TO RELATED APPLICATIONS

This patent application is a continuation in part and claims the benefit of U.S. patent application Ser. No. 18/749,606 titled ARTIFICIAL INTELLIGENCE ANALYSIS FOR IMAGING FLOW CYTOMETRY filed by inventors Vidya Venkatachalam on Jun. 20, 2024, incorporated herein for all intents and purposes. U.S. patent application Ser. No. 18/749,606 claims the benefit of U.S. Provisional Patent Application No. 63/522,133 titled “ARTIFICIAL INTELLIGENCE FOR IMAGING FLOW CYTOMETRY” filed on Jun. 20, 2023, by inventor Vidya Venkatachalam et al., incorporated herein for all intents and purposes. This patent application claims the benefit of U.S. Provisional Patent Application No. 63/522,398 titled “METHODS OF ARTIFICIAL INTELLIGENCE FOR IMAGING FLOW CYTOMETRY” filed on Jun. 21, 2023, by inventor Vidya Venkatachalam et al., incorporated herein for all intents and purposes. This patent application claims the benefit of U.S. Provisional Patent Application No. 63/522,400 titled “SYSTEMS FOR ARTIFICIAL INTELLIGENCE FOR IMAGING FLOW CYTOMETRY” filed on Jun. 21, 2023, by inventor Vidya Venkatachalam et al., incorporated herein for all intents and purposes.

This patent application is further a continuation in part and claims the benefit of U.S. patent application Ser. No. 18/647,366 titled COMBINING BRIGHTFIELD AND FLUORESCENT CHANNELS FOR CELL IMAGE SEGMENTATION AND MORPHOLOGICAL ANALYSIS IN IMAGES OBTAINED FROM AN IMAGING FLOW CYTOMETER filed by inventors Alan Li et al on Apr. 26, 2024, incorporated herein for all intents and purposes. U.S. patent application Ser. No. 18/647,366 is a continuation of U.S. patent application Ser. No. 17/076,008 titled METHOD TO COMBINE BRIGHTFIELD AND FLUORESCENT CHANNELS FOR CELL IMAGE SEGMENTATION AND MORPHOLOGICAL ANALYSIS USING IMAGES OBTAINED FROM IMAGING FLOW CYTOMETER (IFC) filed by inventors Alan Li et al on Dec. 16, 2022, incorporated herein for all intents and purposes.

This application incorporated by reference U.S. patent application Ser. No. 17/016,244 titled USING MACHINE LEARNING ALGORITHMS TO PREPARE TRAINING DATASETS filed on Sep. 9, 2020, by inventors Bryan Richard Davidson et al. for all intents and purposes. For all intents and purposes, Applicant incorporates by reference in their entirety the following U.S. Pat. Nos. 6,211,955, 6,249,341, 6,256,096, 6,473,176, 6,507,391, 6,532,061, 6,563,583, 6,580,504, 6,583,865, 6,608,680, 6,608,682, 6,618,140, 6,671,044, 6,707,551, 6,763,149, 6,778,263, 6,875,973, 6,906,792, 6,934,408, 6,947,128, 6,947,136, 6,975,400, 7,006,710, 7,009,651, 7,057,732, 7,079,708, 7,087,877, 7,190,832, 7,221,457, 7,286,719, 7,315,357, 7,450,229, 7,522,758, 7,567,695, 7,610,942, 7,634,125, 7,634,126, 7,719,598, 7,889,263, 7,925,069, 8,005,314, 8,009,189, 8,103,080, and 8,131,053.

### FIELD

The embodiments of the invention relate generally to artificial intelligence to detect and classify images of biological cells flowing in a fluid captured by an imaging flow cytometer.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a block diagram of an embodiment of an artificial intelligence (AI) imaging flow cytometer system.

FIG. 1B is a schematic view of a computer network for deploying embodiments.

FIG. 1C is a block diagram of a computer node in the computer network shown by FIG. 1B for deploying embodiments of the artificial intelligence (AI) imaging flow cytometer system.

FIGS. 2A-2B illustrate the two types of data inputs into the AI imaging analysis device/software.

FIG. 3A illustrates exemplary multispectral image inputs into the AI imaging analysis device/software and the feature extraction device/software.

FIG. 3B illustrates exemplary numeric feature outputs from the feature extraction device/software that can be input into the AI imaging analysis device/software.

FIG. 4 illustrates an example of a convolutional neural network with exemplary image features that can be extracted from multispectral image inputs.

FIG. 5 illustrates an example of a random forest algorithm partitioning cells in cell images into data partitions based on numeric features.

FIG. 6 is a flow chart of model training for the AI imaging analysis device/software.

FIGS. 7A-7B are cellular images of cells having DNA damage and proliferation for an example experiment.

FIG. 7C is a chart multispectral imaging of cells using brightfield, Hoechst, nuclear mask, and an MN mask for the example experiment shown by FIGS. 7A-7B.

FIG. 8 is a flow chart of the workflow around the AI image analysis device/software.

FIGS. 9-12 are portions of graphical user interfaces (GUI) displayed on a display device to create a new experiment to be analyzed with the AI image analysis device/software.

FIG. 13 is a tagging user interface displayed on a display device to tag events and assign them to an appropriate class to form one or more ground truth populations.

FIGS. 14A-14B are results user interface windows displayed on a display device to view results and generate reports from the AI image analysis device/software based on the input images and numeric data for various AI classifiers.

FIG. 14C illustrates a create report popup window that can be used generate a printout of a report associated with the results user interface windows.

FIGS. 15A-15E are graphs and charts of information included in a generated report.

### DETAILED DESCRIPTION

In the following detailed description of the disclosed embodiments, numerous specific details are set forth in order to provide a thorough understanding. However, it will be obvious to one skilled in the art that the disclosed embodiments may be practiced without these specific details. In other instances, well known methods, procedures, components, and subsystems have not been described in detail so as not to unnecessarily obscure aspects of the disclosed embodiments.

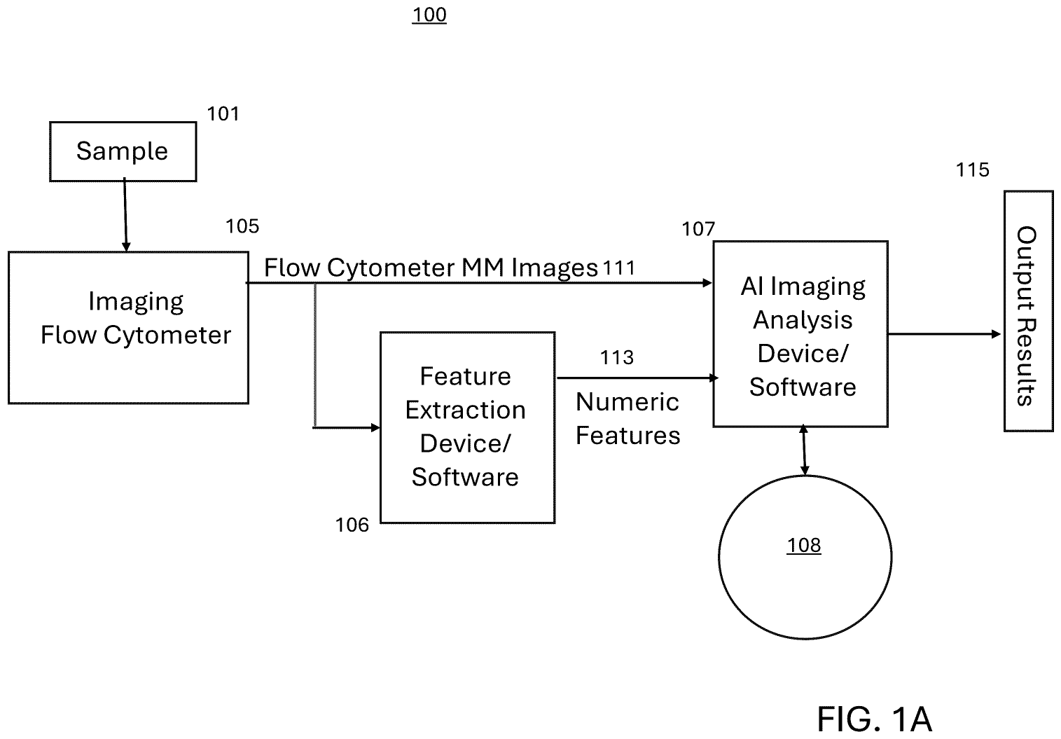

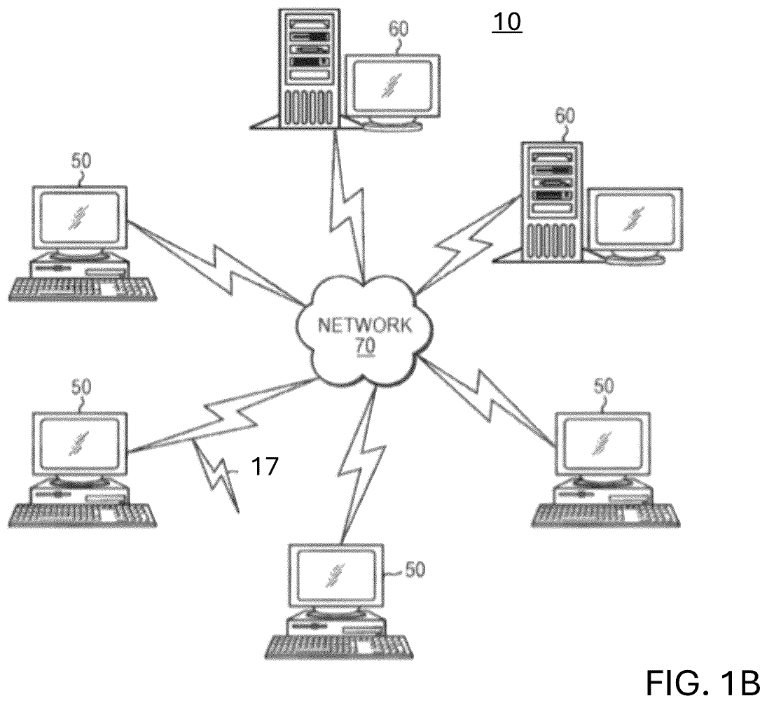

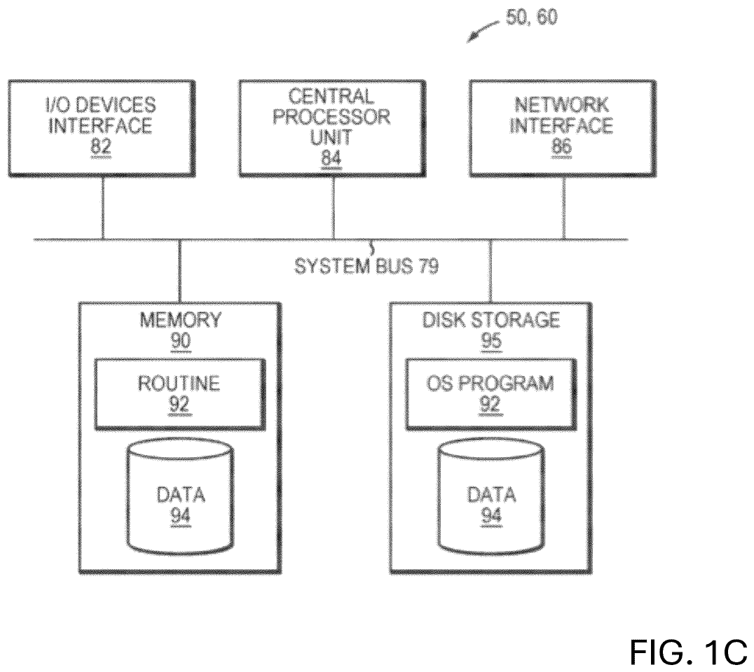

FIG. 1 illustrate an artificial intelligence (AI) imaging flow cytometer system 100. The system 100 includes a multispectral imaging flow cytometer 105, a feature extraction device/software process 106, and an AI imaging analysis device/software process 107. The feature extraction device (extractor) 106 and the AI imaging analysis device (analyzer) 107 are both computer implemented devices formed by the execution of software. The AI imaging analysis device (analyzer) 107 is coupled in communication with a storage device 108 to store files of numeric feature data and associated image data, AI models, and training images and data in databases. Deep learning AI models for cell images are often trained with large cell image databases.

A biological sample 101 of interest, such as bodily fluids or other material (medium) carrying subject cells is provided as input int the multispectral imaging flow cytometer 105. The imaging flow cytometer 105 combines the fluorescence sensitivity of standard flow cytometry with the spatial resolution and quantitative morphology of digital microscopy. An example imaging flow cytometer is the AMNIS IMAGESTREAM manufactured by Applicant. Other imaging flow cytometers that can generate multi-model or multispectral images of each biological cell are suitable.

The imaging flow cytometer 105 is compatible with a broad range of cell staining protocols of conventional flow cytometry as well as with protocols for imaging cells on slides. See U.S. Pat. Nos. 6,211,955; 6,249,341; 7,522,758 and “Cellular Image Analysis and Imaging by Flow Cytometry” by David A. Basiji, et al. published in Clinical Laboratory Medicine 2007 September, Volume 27, Issue 3, pages 653-670 (herein incorporated by reference in their entirety).

The imaging flow cytometer 105 electronically tracks moving cells in the sample with a high resolution multispectral imaging system and simultaneously acquires multiple images of each target cell in different imaging modes. In one embodiment, the acquired images 121 of a cell include: a side-scatter (darkfield) image, a transmitted light (brightfield) image, and a plurality of fluorescence images of different spectral bands. Importantly, not only are the cellular images (i.e., images of a cell) simultaneously acquired but they are also spatially well aligned with each other across the different imaging modes. Thus, the acquired darkfield image, brightfield image and fluorescence images (collectively multispectral images 111) of a subject cell are spatially well aligned with each other enabling mapping of corresponding image locations to within about 1-2 pixels accuracy.

The acquired cellular multispectral images 111 are output from imaging flow cytometer 105 and coupled into the computer-implemented feature extraction device 106 and the computer-implemented AI imaging analysis device 107. For a non-limiting example, embodiments may employ an input assembly for implementing streaming feed or other access to the acquired images 111. The computer-implemented feature extraction device 106 and the computer-implemented AI imaging analysis device 107 can be configured to automatically analyze thousands of cellular images 111 in near real time of image acquisition or access, and to accurately identify different cellular and subcellular components of the sample cells being analyzed. Each multispectral image 111 of a cell has different cellular components and different subcellular components representing cells in the sample. A given cellular component may be formed of one or more image subcomponents representing parts (portions) of a cell.

The acquired cellular multispectral images 111 are coupled into both the feature extraction device 106 and the AI imaging analysis device 107. Numeric features of each cell in each multispectral image 111 are extracted by the feature extraction device 106. Image features of each cell in each multispectral image 111 are extracted by the AI imaging analysis device 107. Advanced shape image features such as contour curvature and bending scope can be determined from a brightfield image in each multispectral image 111. With both numeric features and image features, the AI imaging analysis device 107 can further classify the cell type and cell morphology of each cell in each multispectral image 111. Complex cell morphologies can be determined such as fragmented or detached cells, stretched or pointed cell boundary, etc. in the sample cells.

Based on the numerical feature inputs 113 and the acquired cellular multispectral images 111, the output results 115 of the AI imaging analysis device 107 (and thus system 100) provides indications of identified cell morphologies and/or classification of cell type. A computer display monitor or other output device (e.g., printer/plotter) may be used to render these output results 115 to an end-user.

### Machine Learning

Manual analysis of images of biological cells has multiple pain points. Manual analysis has a very steep learning curve. A user really needs to know about the data that can be acquired from an imaging flow cytometer. Moreover, a user really needs to know the tools that can be used to effectively analysis that data to create useful results. Additionally, manual analysis is very prone to bias and subjectivity. When manually looking at cells, everyone has their own way of doing things and sometimes you end up with differences in opinion. Manual analysis typically lacks repeatability and standardized workflows. It's very difficult for a large number of people to all follow the same set of manual steps and come out with the same output.

The AI imaging analysis device/software 107 offers multiple benefits to counteract some of these pain points with manual analysis. The AI imaging analysis device/software 107 has an intuitive design that is easy and effective to follow. The AI imaging analysis device/software 107 offers objective and repeatable analysis. The AI imaging analysis device/software 107 has scalable workflow options, and it is shareable across multiple users. Importantly, the AI imaging analysis device/software 107 supports diverse data sets. From animal fertility, phytoplankton, micronuclei, you can load any data into the AI imaging analysis device/software 107 and get started with your analysis. Moreover, the AI imaging analysis device/software 107 requires no coding knowledge. A user does not need to know any type of programming in order to successfully use the AI imaging analysis device/software 107.

### Image Flow Cytometry Analysis

The AI imaging analysis device/software 107 uses AI-powered analysis to significantly simplify the workflow of analyzing data from an imaging flow cytometer or other instruments that can provide multispectral images. The AI imaging analysis device/software 107 has a deep neural network model for image classification with a database 108 that is optimized to handle large data sets. A user can classify their own data using a pre-existing model, or a user can train a new model using their own new data. Training a new model requires generating tagged truth data. The AI imaging analysis device/software 107 has an AI assisted tagging module to assist users in forming tagged truth data. The user interfaces of the AI imaging analysis device/software 107 provide an interactive results gallery so a user can explore the outputs of their model. The user interfaces of the AI imaging analysis device/software 107 provide report generation to neatly summarize results for a user.

The AI imaging analysis device/software 107 is intuitive allowing users to build robust machine learning pipelines. A user has access to multiple algorithms and can ingest imaging and feature data generated from various instruments, including imaging flow cytometers, such as the AMNIS IMAGESTREAM MK 2 and the AMNIS FLOWSIGHT imaging flow cytometers.

There is a need to simplify the analysis workflow of cellular images from biological samples and improve efficiency. There is a need to reduce ramp-up time for new users to analyze cellular images from biological samples. It is desirable to put machine learning in the hands of any user, regardless of their technical background. This can be accomplished by providing an easy-to-follow step-by-step process that lets users efficiently tag data, utilize pre-optimized machine learning algorithms and view their concise results.

Data Inputs into AI Imaging Analysis Software

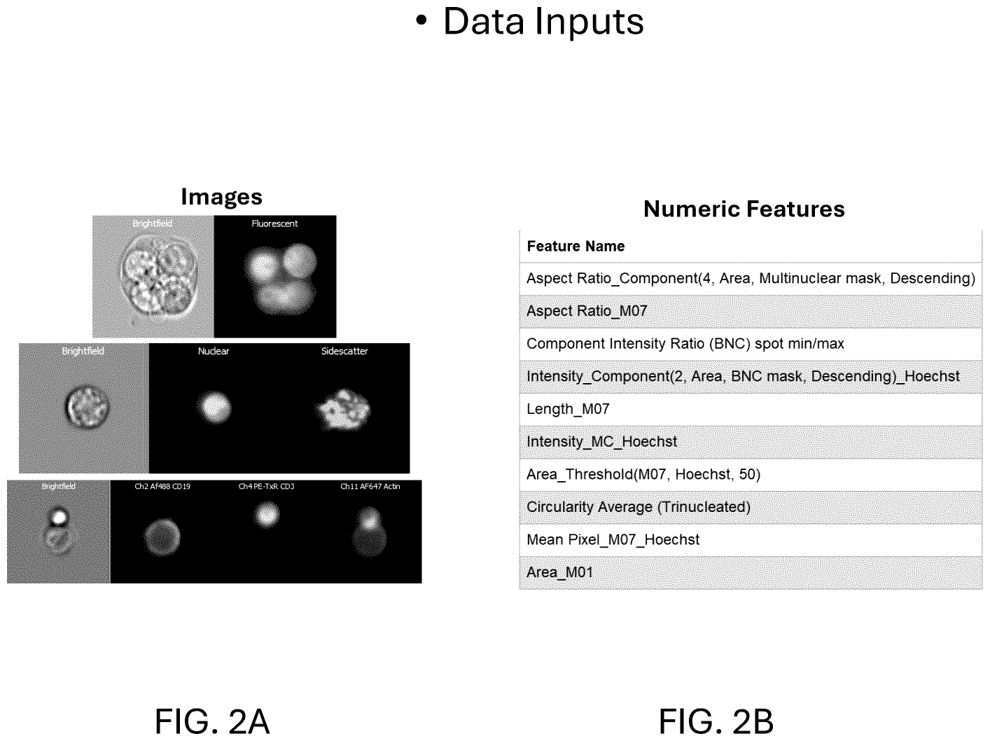

Referring now to FIGS. 2A-2B, the AI image analysis software can have two different kinds of data inputs. A first data input are images, and a second data input are numeric features. Previously, only image inputs were supported. While images are effective to work with alone, powerful extracted numeric features generated by feature extraction software can be fused together with the image feature extraction to provide more rapid and improved classification results by the AI image analysis device/software. Both images and features are supported data inputs into the AI image analysis software.

### Images

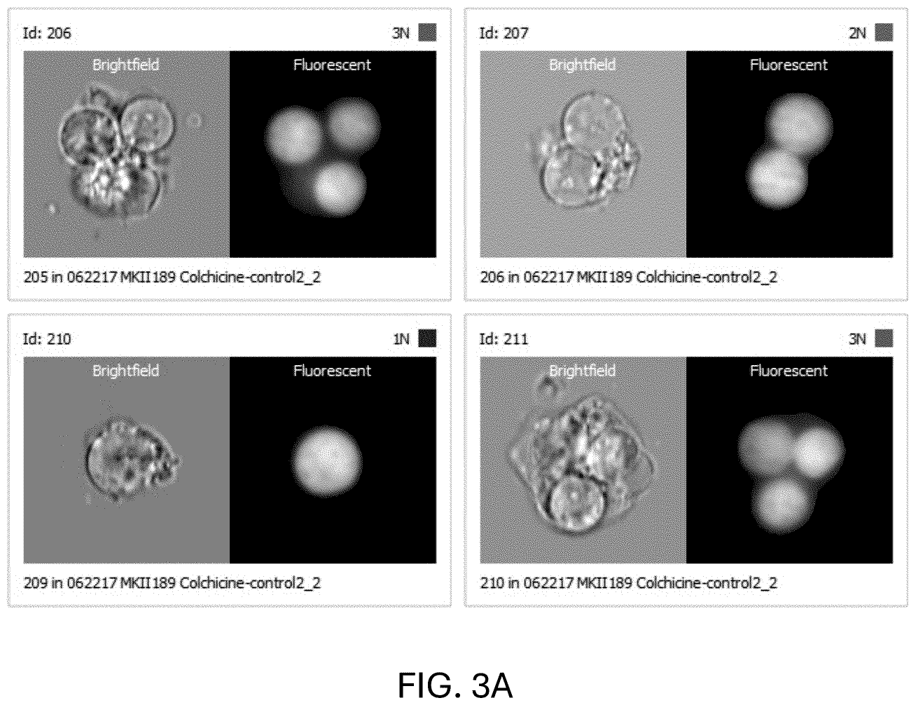

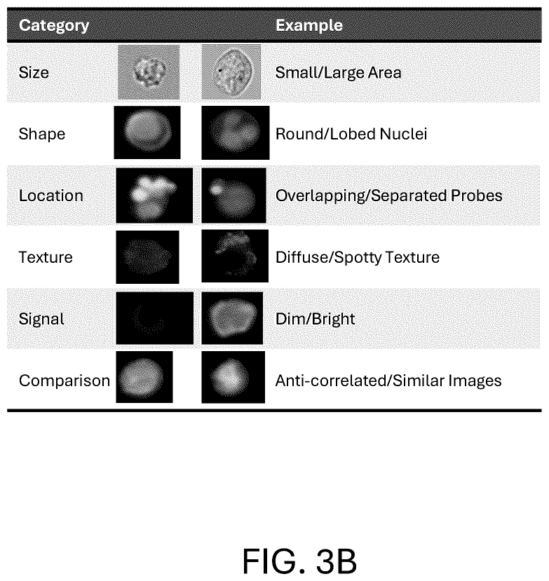

Referring now to FIG. 2A, one type of data input to the AI analysis software are images captured by the imaging flow cytometer. Each image of each cell are multispectral images captured using different modalities. These can be a brightfield image, darkfield image, nuclear image (cell nucleus), side scatter image, and one or more fluorescent images captured by shining different lasers and exciting different florescent dyes marking selective cells causing fluorescent light or the cell itself causing it to autofluorescence. The plurality of images making up a multispectral image of a cell can be used together to capture image features and numeric features to aid in classification of cell type and cell morphology. FIG. 3A illustrate using a brightfield image and a fluorescent image of four different cell images. One image in FIG. 3A is a single cell image. The other three images appear to be multiple cells that can be readily discerned by the fluorescent image and not so much by the brightfield image. The edges of the cells are easier to determine from the brightfield images.

A key benefit to using images of cells as an input is that they can simplify the classification workflow. No feature engineering or feature extraction is required. Instead, one can immediately start doing analysis on the image data of the cells that is directly output from the imaging flow cytometer. However, while using images can accelerate data exploration, it comes at a computational complexity cost. Operating on raw images consumes more computing time than operating on numeric features. This is because images maintain all available spatial data. Spatial data comes in a very high dimensional format. There is a tremendous amount of information in image data, but it takes more time to process it. Another key benefit using images output from an imaging flow cytometer is that they're very easily accessible. With traditional flow cytometer event data from photo detectors or photo multiplying tubes, compensation is often required to get accurate results. With traditional flow cytometer event data, each interrogation event of a cell with a laser that is captured by photodetectors, must be preprocessed to make some sort of sense about the biological cell. In summary, images preserve all available spatial data and can be quickly collected with an AMNIS IMAGESTREAM MK 2 imaging flow cytometer.

### Numeric Features

Referring now to FIGS. 2B and 3B, a second input into the AI analysis software are numeric features that can be extracted from the multispectral images by feature extraction algorithms. There are a number of different numeric features that can be extracted and used for AI analysis of cell images. Using feature extraction software on the images of cells, a wide range of numeric features can be extracted for use with machine learning algorithms.

FIG. 3B illustrates a table of example numeric features broken up by category. Some features that may be desirable to use by the AI software in classification include size, shape, location, texture, signal, and comparison. The size of a cell may be determined from area in the image and indicated as having a small area (left side example) or a large area (right side example) based upon a comparison with a predetermine value (e.g., 10 square nanometers, equal to and above deemed large, and less than deemed small), for example. The shape of a cell may be determined from the cell image and deemed round or lobed nuclei, for example. The location of a component (e.g., nucleus) with other parts of a cell may be determined from the cell image and deemed overlapping or separated probes, for example. The texture of the cell may be determined from the cell image and deemed diffuse or spotty. The signal level of the cell in the image can be determined and deemed dim (left side example) or bright (right side example). A comparison of the acquired cell image with a selected truth cell image can be made and a determination made whether or not they are similar images with correlation (right side example) or different with anti-correlation (left side example). Numeric features have a lower computational cost than their image counterparts, particularly when you are sorting through many images (e.g., thousands). Using numeric features as a first cut in classification can more quickly sort through a batch of multispectral images of the numerous biological cells that may be found in a sample. However numeric features obviously do not maintain all available spatial data from the source images. Additionally, if the numeric features one chooses are not comprehensive enough, the classification algorithms can still struggle classifying images of cells in a quick manner. Features generated by default, as well as custom features can be used to create a detailed and informative description of the captured image data when a user experiment is run.

In any case, numeric features are preferably a second input into the AI analysis software that can be used by the multiple AI algorithms.

### Convolutional Neural Network

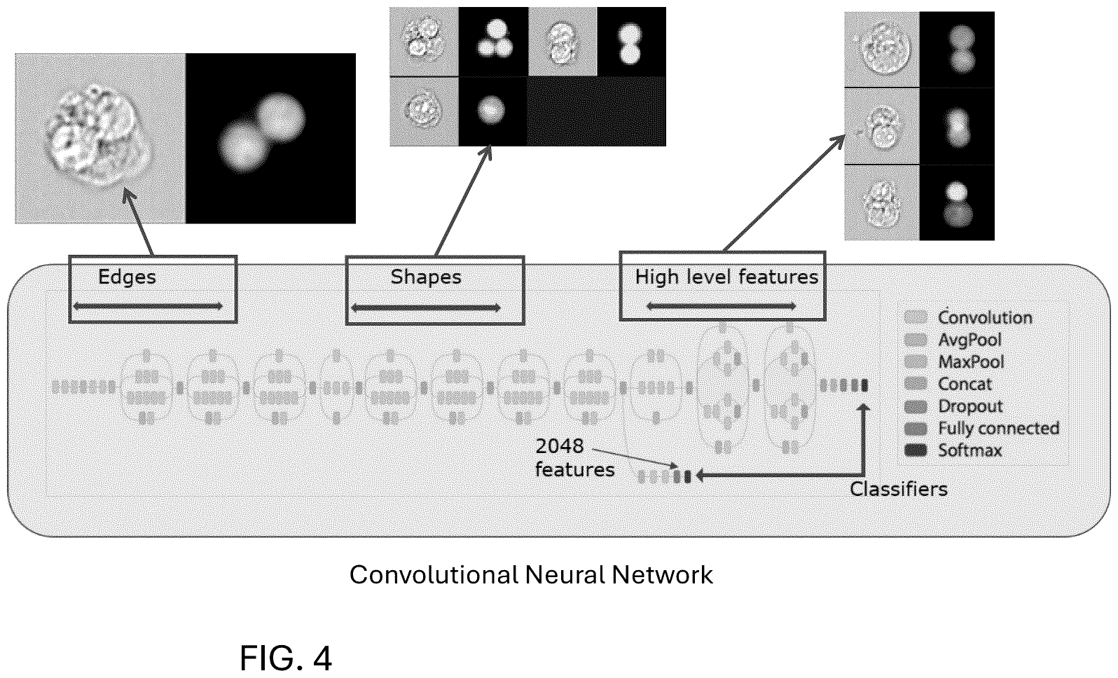

Referring now to FIG. 4, a first AI algorithm used to process each of the multispectral cellular images is a convolutional neural network (CNN) for image processing and image feature extraction. A convolutional neural network handles the high dimensionality of images by convolving over each image to learn its features and this maintains all the spatial data available. The CNN also utilizes a deep learning architecture however this makes it what's called a black box solution which means that they're not explainable. You can't step through the logic on a piece of paper to outline exactly how your CNN went from the image input to the output label.

CNNs are an industry standard in image classification. They are composed of multiple building blocks that are designed to automatically and adaptively learn spatial hierarchies of features. This enables them to handle the high dimensionality of images very well and of course as mentioned, this is what results in that black box solution. While highly effective in handling two dimensional imagery, CNNs take longer to train especially as the size of the input image grows. Thus, the CNN takes longer to train than other numeric based algorithms. The CNN in the AI Analysis software is fully optimized for biological imagery. It is pretrained to handle a diverse set of biological applications that a user is interested in with the images captured by an imaging flow cytometer.

A CNN has multiple layers (shown from left to right in FIG. 4) to process the multispectral cellular images and obtain desired image features. For example, in the earlier layers of the CNN (left side), the CNN can learn about the edges of the cell using the multispectral image. Moving deeper into layers of the CCN, other features can be discovered about the cell from the multispectral image, such as the shape of the cell. Moving into the deepest layers of the CNN, high-level image features can be determined from the multispectral image. Convolution of the image and the prior training of the parameters of the CNN extraction of image features possible. CNNs maintain all spatial data from input images and require no additional manual intervention to train. Because they use deep learning architectures, CNNs offer a specialized, deep learning method for image classification. CNNs are often considered a “black box” solution to image classification. A second algorithm in AI imaging analysis software is a random forest algorithm.

### Random Forest

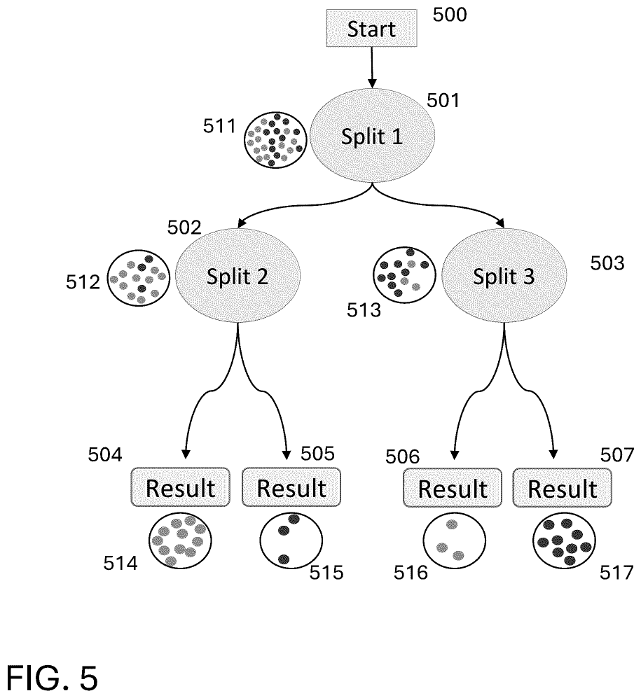

Referring now to FIG. 5, a random forests algorithm acts like one gets to choose your own adventure. The random forest algorithm start out at a starting point 500 with lots of possible options and based on the decisions that are made so one eventually narrows down to one or more final results 504-507. The random forests algorithm allows a user to gain some insight into which features have the most impact on the data in their image flow cytometry experiment. As one moves down the random forest from the start 501, the goal is to reduce heterogeneity. That is, it is desirable to increase homogeneity down the tree of the random forest. As the data is split into branches of classes, the goal is to have more of each class in each data partition.

Before a first split 501, in data partition 511 there appears to be an equal number of red and blue dots representing an equal number of different cell types. The first split 501 may be based on a numeric feature (e.g., cell area size) or an image feature (e.g., round shape) for the multispectral cell images. The first split 501 results in a data partition 512 having more blue dots than red, and a data partition 513 having more red dots than blue. At a next level, a second split 502 can be performed on the data partition 512 and a third split 503 can be performed on the data partition 513. The second split 502 on the partition 512 results in all blue dots in data partition 514 for result 504 and all red dots in partition 515 for result 505. The third split 503 on the partition 513 results in all blue dots in data partition 516 for result 506 and all red dots in partition 517 for result 507. Thus, as the algorithm moves down levels or branches and continues splitting, gradually a majority of a single class falls into each data partition 514-517.

A random forest algorithm has a couple strengths that can make them very powerful. The first is that a random forest algorithm can handle high dimensionality of numeric data very well. A random forest algorithm can also handle multiple types of features whether they be continuous or categorical. The random forest is also robust as to outliers and to unbalanced data such that a random forest results in a low bias moderate variance model.

### Modeling Pipeline

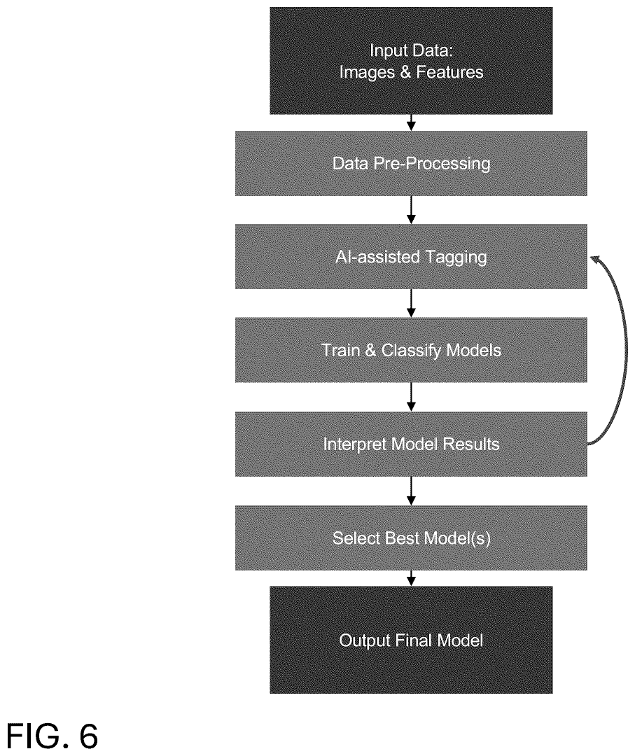

Referring to FIG. 6, the AI analysis software of the images captured by the imaging flow cytometer provides access to multiple machine learning and AI algorithms. This changes the analysis pipeline some because as you walk through the data/image analysis process, you want to evaluate which model may works best for the experiment you are trying to run. You can still iteratively tag data using AI-assisted clustering. However, you can train models using different available AI algorithms on the same input data and compare output results to determine which AI algorithm is better to use. A user can also output reports of the results and save user trained algorithms for future classification experiments.

Notice here where we want to interpret the model results on the left. It may be that you can use the output of one model to inform some information about your data. Maybe both models are struggling to classify the same classes, and you can use that information to go back and revise your tagged data in order to optimize your performance and start to get better results. Most importantly, a flexible machine learning pipeline lets you find the best model for your data. All data sets are different, and your needs are different. This flexible pipeline really allows you to adapt it to your needs.

### Example Case Study

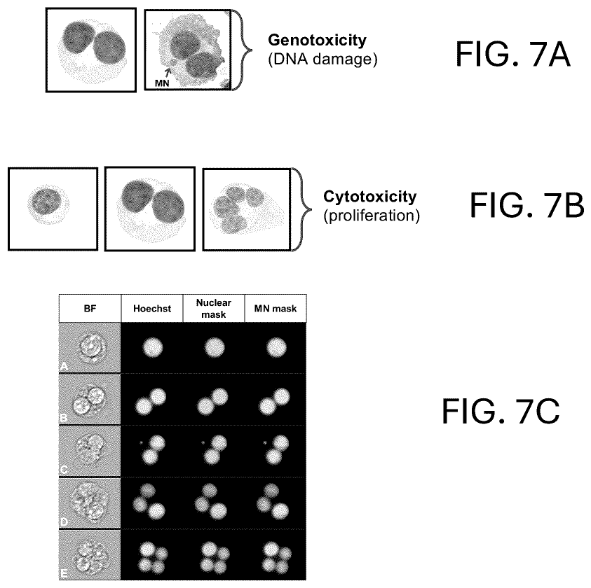

Referring now to FIGS. 7A-7C, an example of using the AI imaging analysis software is now discussed that addresses micronuclei population assignment. The in vitro micronucleus assay is an established test for evaluating genotoxicity and cytotoxicity. Performing the assay through manual microscopy is labor intensive and is very prone to inner score variability. You can use the feature extraction software first to identify populations using human engineered features in gating. However, the workflow that comes from that is not very flexible. Variations in new data and identifying robust features requires expert knowledge. However, the AI imaging analysis software can help. Using AI imaging analysis software with the micronuclei images as inputs for the convolutional neural network, one can achieve greater than 95 percent accuracy in identifying micronuclei and all key events. The CNN did not require any feature calculation or gating, The CNN handles variation in the data successfully so that is it much more robust and effective for long-time analysis.

### Background

In FIG. 7A, the micronuclei represents DNA damage. In FIG. 7B, the micronuclei represents proliferation (Cytotoxicity).) The assay is generally used for genetic toxicology, radiation bio dosimetry, and biomonitoring. It's typically scored via visual microscopy which requires skilled operators and is highly subjective. It can be scored using slide scanning microscopy which requires very high-quality slides. One can try to use conventional flow cytometry, but it would not provide any images and can often result in false positives. One can try using imaging flow cytometry by itself. However, intensive feature engineering may be needed.

### Setup

The experiment is setup via a couple of steps. First the cells are treated with colchicine to induce micronuclei and cytochalasin-B to block cytokinesis. The cells are harvested, fixed, and stained with Hoechst dye to label DNA. The stained cells are then run through an image flow cytometer and image data is collected on channel 1 (Brightfield) images and channel 7 (Fluorescent) nuclear images using an AMNIS IMAGESTREAM Mk II imaging flow cytometer.

To analyze the data, three steps were used. The first step was the image files were processed with the feature extraction software to remove unwanted images. A gold standard truth series of images were then created for each class that we wanted to classify in the experiment. The files were then processed using the AI imaging analysis software to classify each class within the model.

### Data Overview

As an overview of the data collected for the experiment, six classes were defined to classify the cellular images including mono, mono with micronuclei, BNC, BNC with micronuclei, multinucleated, and irregular morphology. There were 325000 objects in the experiment. Of the 325000 objects in the experiment, 31500 have a truth label. Class balancing is handled internally by the AI imaging software. The collected data was split into eighty percent for training, ten percent for testing, and ten percent for validation.

### Graphical User Interface

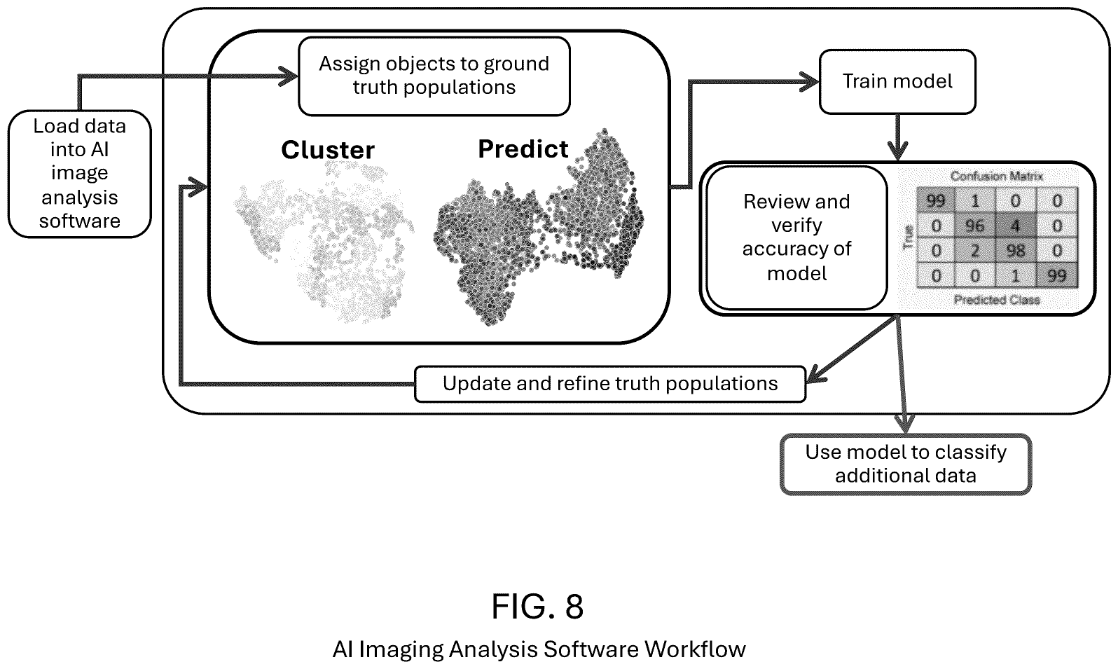

FIG. 8 is a flow chart of the workflow around the AI image analysis device/software. The imaging flow cytometer data (multispectral images) and numeric feature data is loaded into the AI analysis software. A user assigns objects to classes of ground truth populations. The analysis software can cluster similar objects together and use the ground truth populations to make predictions on a training portion of the database. This effectively trains a model to the multispectral images of interest. The results of the model are reviewed to verify its accuracy. If the results are sufficiently accurate, the model can then be used to classify additional data on its own without user intervention. If not, the model can go through an update process with the training set where ground truth populations can be refined to try and provide improved results.

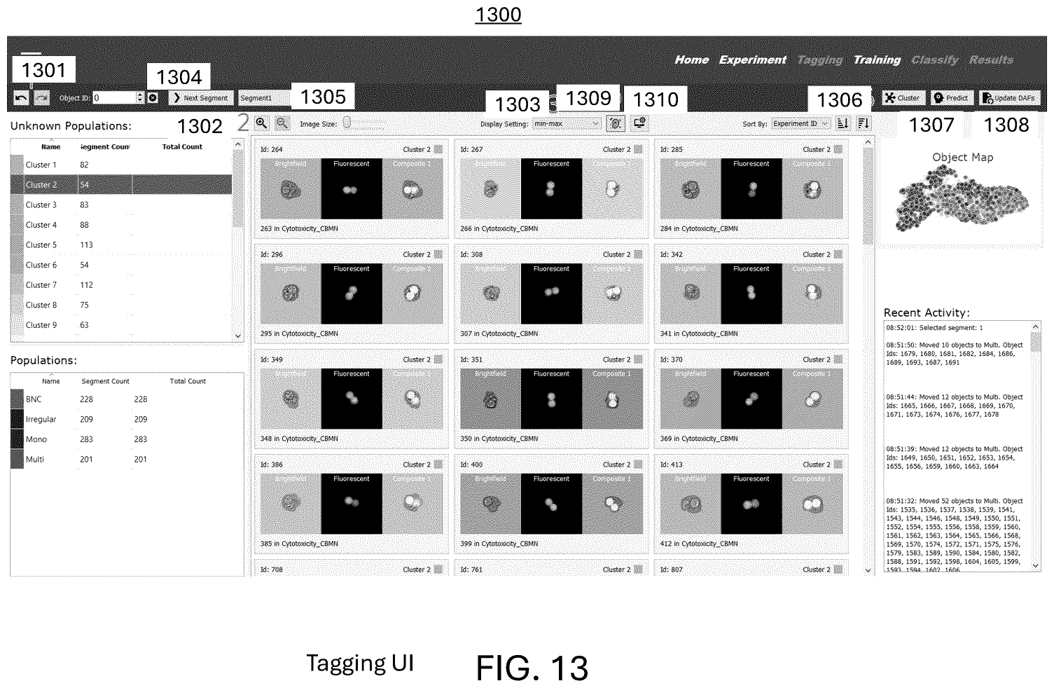

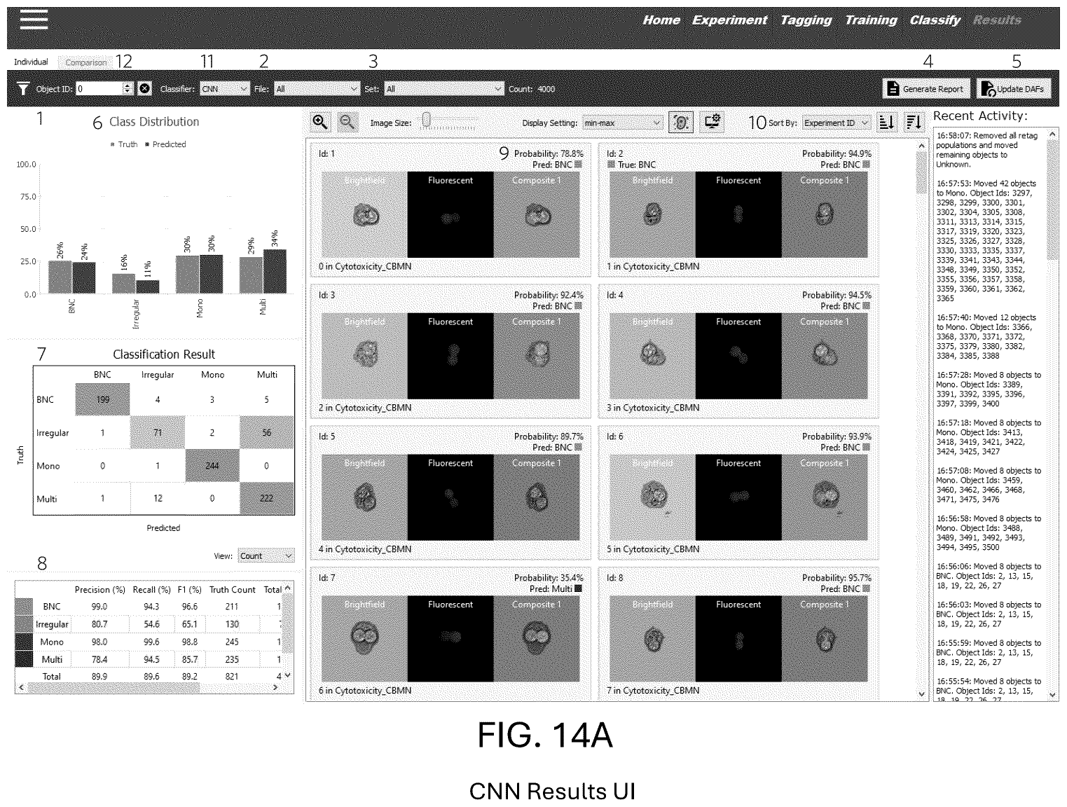

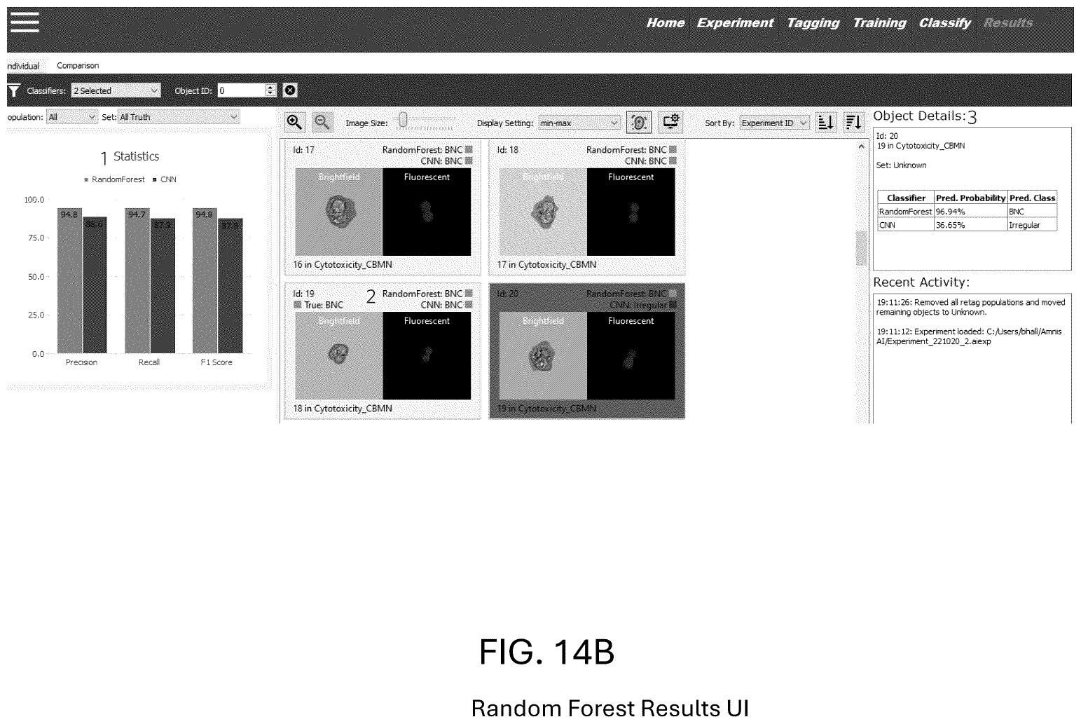

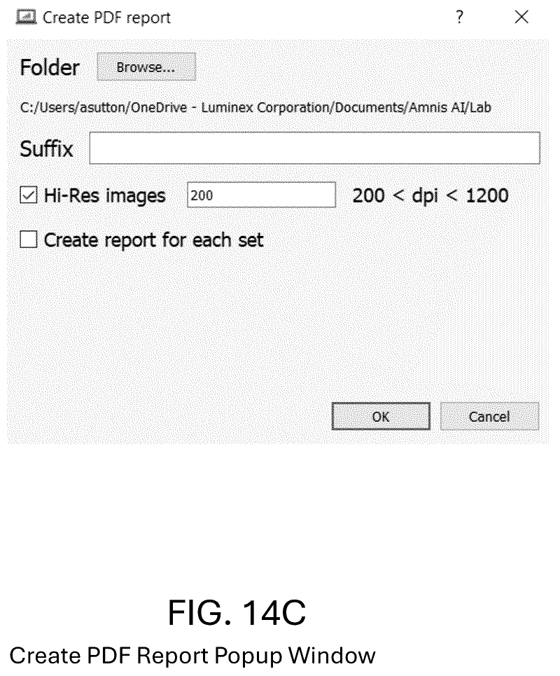

The AI image analysis software allows users to build classification models from image flow cytometer (IFC) data, multispectral images, based on convolutional neural networks and numeric features extracted by feature extraction software. A user does not need computer coding knowledge. The workflow is user interface (UI) based so it walks a user through the steps like a software wizard. After logging in with user ID and password, the AI image analysis graphical user interface (GUI) has tabs (see Home, Experiment, Tagging, Training, Classify, and Results tabs in FIG. 13) along a top bar in the GUI window. The tabs in the tab bar can be selected to open windows of the software wizard including a home window, an experiment window, a tagging window, a training window, a classify window, and a results window associated with the respective tabs. The windows are displayed on a display device below the top bar, a menu/button selection bar, and other bars as needed by the context as can be seen in FIG. 14A, for example.

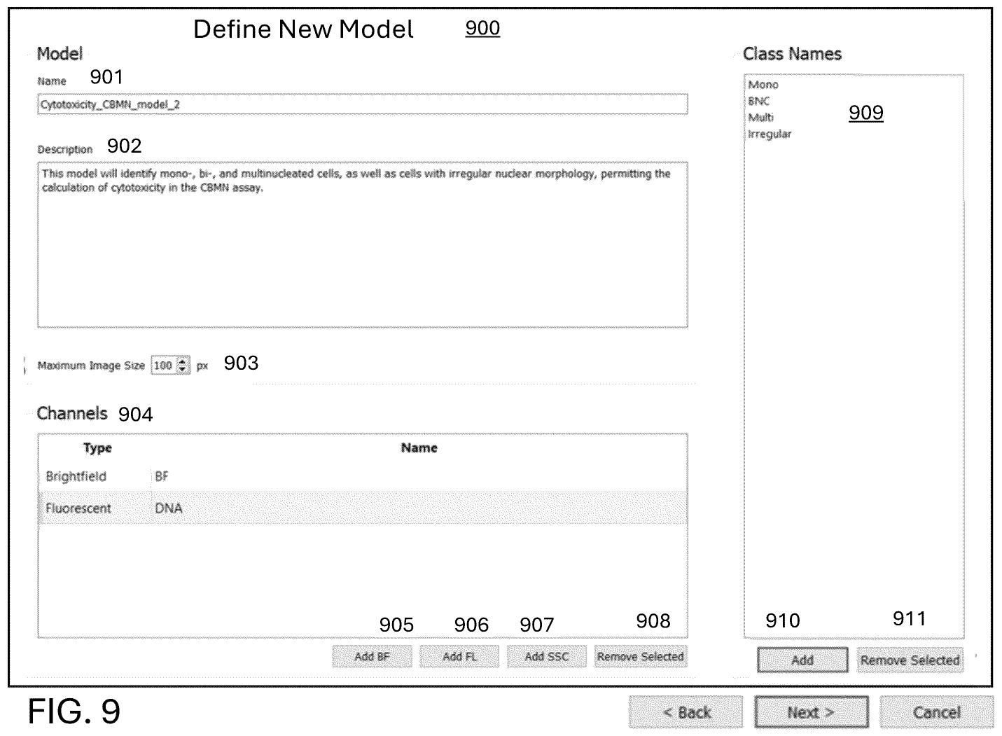

FIGS. 9-12 are portions of AI image analysis GUI displayed on a display device with the experiment window tab selected to create a new experiment to be analyzed with the AI image analysis device/software. The AI image analysis software allows the creation of two experiment types: a Training experiment and a Classification experiment. A Training experiment creates a new classification model based on ground truth images, channels, and class names defined by the user. Ground truth images may be imported from the Feature Extraction software or defined by using the tagging tool within the AI imaging analysis software. A Classification experiment applies an existing model (previously created in a Training experiment) to classify new data. The AI imaging analysis software walks a user through a series of steps when creating a new experiment. The process for creating a Training experiment and a Classification experiment is almost identical.

To create a New Experiment a user first opens the AI imaging analysis software, logs in with user id and password as need so that a New Experiment window is displayed on a display device. A user clicks on a folder icon so that a user can browse to a location where the using wants to save the experiment. The user can then click Select Folder and enter a name for the experiment in the Name field.

A user then chooses to either create a Training experiment or a Classification experiment in the Experiment Type section. To create a Training experiment, the user selects Train for the Experiment Type. To create a Classification experiment, the user selects Classify for the Experiment Type. If the user selects to create a Training experiment, the Select Template Model is displayed, and the user then clicks Next to create a new model. If the user selects to create a Classification experiment, the Select Model for Classification window is displayed. \

Referring now to FIG. 9, if the user desires to create a training experiment for a new model, the Define New Model window 900 is displayed to describe model information. The model information can still be edited after creating an experiment. Doing so does not overwrite the new model. However, adding or removing classes and/or channels will overwrite the model. The Define New Model window 900 includes a Name field 901 to associate a name for the new model. It further includes a Description field 902 to add a description for the new model. This field is optional. A Maximum Image Size field 903 is provided to set the maximum image size in square pixels. A value of 150 pixels can be used to properly segment images.

A Channels subwindow 904 is provided to add and display the selected data channels for the new model definition. A number of buttons under the channel window 904 are used to control the channels that are in the channels subwindow. An Add BF button 905 adds a Brightfield (BF) channel to the model definition. An Add FL button 906 adds a fluorescent (FL) channel to the model definition. There is no limit to the number of fluorescent channels that can be created. Each fluorescent channel can be given a specific name such as to identify what feature may be revealed. An Add SSC button 907 adds a side scatter (SSC) channel to the model definition. A Remove Selected button 908 removes a selected class from the model definition that was previously added.

A Class Names subwindow 909 is provided to list of the classes for the new model definition. The Add button 910 adds a new class to the model definition. A pop-up window is displayed that allows the user to specify a name for the new class. A Remove Selected button 911 removes the highlighted class from the model definition.

The user can enter a name for the model in the Name field of the Define New Model window 900. Optionally, a user can also enter a description for the model in the Description field. In the Channels section, a use can click Add BF, Add FL, or Add SSC buttons 905-907 to add channels to the model as needed. At least two channels for multispectral cellular images are typically added. In the Class Names section, the user can click an Add button 910 which displays a New Class window. The user can enter a name for the new class and click the OK button to add the new class to the Class Names list 909. A user can add as many classes as need for the new model but at least two classes are needed for a new model to continue the process with the software wizard.

A user can Click the Next button to optionally define a model with a template from the feature extraction software. A user can browse for a Feature Extraction template or a DAF and use the check box to include critical features from active channels to create the Random Forest classifier, or to skip this step, a user can click the Next button again to continue. The select data files window displays. Because features are extracted by the Feature Extraction software, data files should have the same analysis template of features to be extracted and include only those channels with critical image data in them.

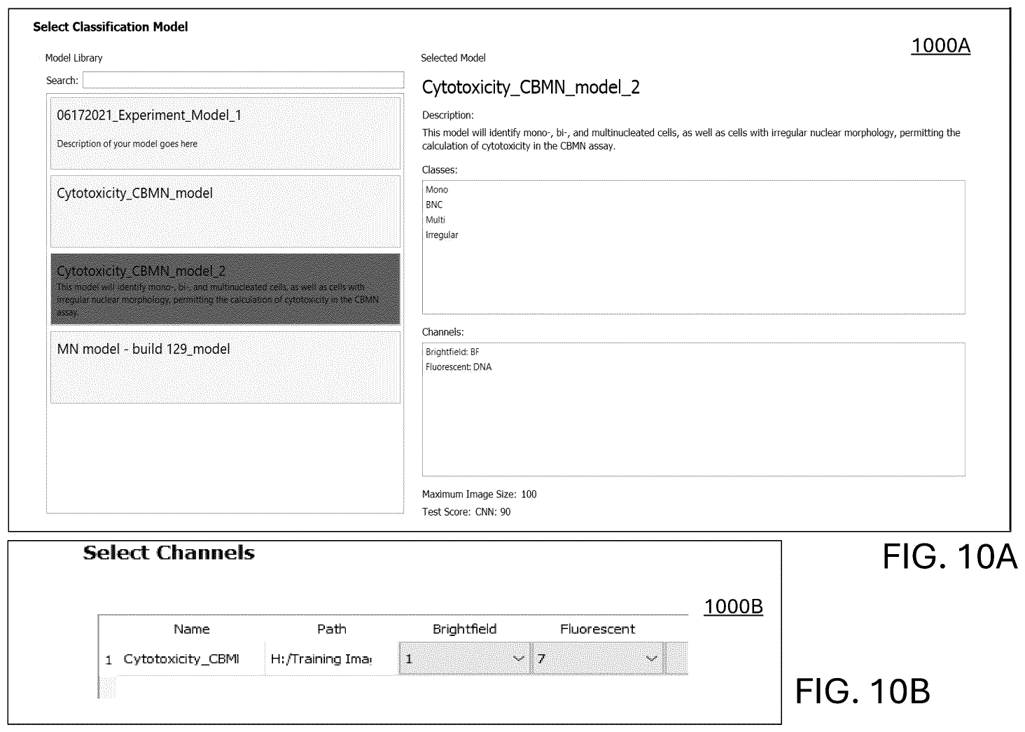

Referring now to FIG. 10A, if the user desires to create a Classification experiment, the user can choose a classification model in the Select Classification Model window 1000A.

The user can choose an AI model from a Model Library subwindow in a section of the Select Classification Model window 1000A. A search field is provided to the user above the Model Library subwindow to enter and search for an AI model to use with AI imaging analysis software in the case of a large Model Library. The models in the Model Library are built from previously created Training experiments.

Selecting a model in the Model Library subwindow provides a summary of the selected model displayed in a right subwindow under a Selected Model heading. The summary includes a description of the model, the classes used in the model and the channels used from the multispectral cellular images. After the user has selected the right AI model, a user can click a Next button in the main window to open a Select Data Files window.

In the Select Data Files window, a user can select the data files to be used for the new AI image analysis experiment. A user clicks on an Add File(s).button to open a field to use to navigate into the database. The user can navigate to the directory that contains the .daf file(s) to add to the experiment. The user can select one or more of .daf file(s) to add. A user can simply select multiple files to add by holding the Ctrl key while clicking the desired files. With the filed selected, a user can Click an Open button to add the file(s) to the file list of data files being used in the experiment. A user can continue to add more files until all the .daf files of interest to use in the experiment have been added. If a mistake is made, a user can remove a file from the list, by right clicking the file path and choose the Remove File option. Assuming the input data file lists is correct of all the multispectral images, a user can click a Next button to then display a Select Base Populations window.

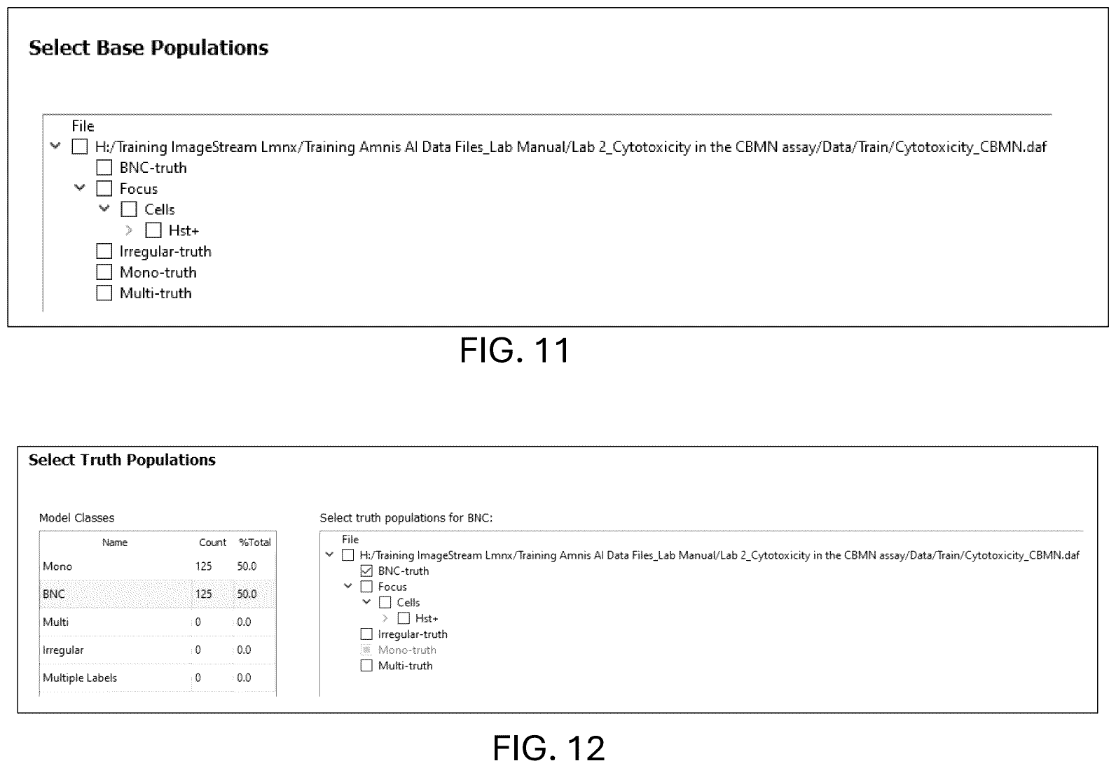

Referring now to FIG. 11, a Select Base Populations window is shown to select base populations for the experiment. From the Select Base Populations window, the user can expand each .daf file by clicking the arrow to the left of each file header check box. The user can select the base population(s) to use in the experiment by selecting the check box next to each population and/or .daf file header you would like to use. The user can click the Next to finish selecting base populations. The Select Truth Populations window is displayed next by the software wizard.

If no base populations are selected, AI imaging analysis device/software sets the All population as the base population. The base population is the parent population for the whole experiment. For example, if you only want to see single cells, select the single cell population. Right-clicking on the file header for the data file or any population reveals a drop-down menu containing options for selecting populations as follows: A Select “All” Population for Files menu item selects the “All” population as the base population in all .daf files that have been added to the experiment. A Deselect “All” Population for All Files clears the “All” population from being the base population in all .daf files that have been added to the experiment. A Select All Matching Populations select matching populations in all .daf files that have been added to the experiment. For example, if “BNC-truth” is the base population in all .daf files, the Select All Matching Populations option selects BNC-truth as the base population in all .daf files that have been added to the experiment. A Deselect All Matching Populations clears specific populations (for example, “BNC-truth”) from being the base population in all .daf files that have been added to the experiment.

Referring now to FIG. 12, a Select Truth Populations window is displayed by the display device to select truth populations for the experiment. If no truth populations are selected, all model classes start with zero objects assigned to them. From the Select Truth Populations window, a user can click the arrow next to a file header to reveal populations that have been created using the Feature Extraction software. Select truth populations can be first selected selecting the model class, then the check box next to the population that is to be included. After selecting all truth populations of interest to include in the experiment, the user can click a Next button that then displays a Select Channels window.

In some experiments, a user may use fluorescent markers to determine the truth population, or a user may have hand-tagged truth populations with the Feature Extraction software or the AI imaging analysis software. In any case, each data file can be expanded to reveal any populations that have been created with the Feature Extraction software. Right-clicking on any population in any file reveals two options for selecting populations: A Select All Matching Populations option selects matching populations in all .daf files that have been added to the experiment. For example, if BNC contains the truth populations, Select All Matching Populations adds all objects in BNC in all files to the selected class. The second option, a Deselect All Matching Populations option clears specific populations (for example, BNC) from being truth populations in all files that have been added to the experiment.

Referring now to FIG. 10B, a Select Channels window 1000B is displayed by the display device to select the channels for the experiment. To edit the channel for a specific fluorochrome (for example, DNA), the user can use the dropdown arrow under the fluorochrome and enter the channel number. It is desirable to use channels with critical morphology for the experiment and avoid those channels that do not. The Brightfield channel is commonly selected with other channels. After selecting the channels, the user can click the next button that then displays a Confirmation window on the display device.

In the confirmation window, a user can confirm the experiment details that were selected. A user can verify that the Location, Model, Experiment Type, and Number of Files are correct. If the experiment details are incorrect, the user can click a Back button to edit the experiment. After confirming the experiment details are correct, the user can click the Create Experiment button so that the new experiment is created with the AI imaging analysis software. The user can then click a Finish button to finish creating the experiment and an initial home menu screen is displayed by the AI imaging software on the display device.

FIG. 13 is a tagging user interface window 1300 displayed on a display device to tag events and assign them to an appropriate class to form one or more ground truth populations. The functionality of the tagging user interface window and the training user interface window are somewhat generally described in U.S. patent application Ser. No. 17/016,244 titled USING MACHINE LEARNING ALGORITHMS TO PREPARE TRAINING DATASETS filed on Sep. 9, 2020, by inventors Bryan Richard Davidson et al. incorporated herein for all intents and purposes.

In FIG. 13, the tagging user interface window 1300 includes a menu/button bar. From left to right, the menu/button bar includes undo/redo buttons 1301; ObjectID pull down menu, Next Segment button 1304, Segment field display 1305, cluster 1306, predict 1307, and update DAFs 1308 buttons. Below the menu/button bar is display bar for the images displayed in subwindows below it. From left to right, the display bar includes zoom in/zoom out buttons, an image size slider, a display setting pull down menu 1303, an image color on/off button 1309, an image setup button 1310, a sort by pull down menu, sorting up/sorting down buttons, and a Show Truth checkbox 1311.

The image setup button 1310 has been used to show unknown populations and known population subwindows on a left side of the Training window. Cluster 2 is currently selected from the unknown population to be displayed in the middle subwindow. In the middle subwindow three columns of four rows of multispectral images from cluster 2 are displayed to the user. In a right subwindow, an object map is displayed showing clustering and a recent activity window is show displaying the recent history of edits to the population with the movement of objects.

The tagging tab is used to create the ground truth population. With the tagging tab selected from the home window or any other, the tagging user interface window 1300 is displayed. A user can then click the next segment button 1304 to choose a segment of population (e.g., segment1) from its drop down menu 1305. An object map plot is displayed with clusters of objects for the selected segment of the population. Typically, fifteen hundred (1500) objects are required to create each segment of population. A user can click the cluster button 1306 to see all the objects in a given cluster in the middle subwindow. A user can click the Show Truth checkbox 1309 to see the truth populations displayed in the object map.

A user can click on the Display Setting drop-down menu 1303 and choose min-max or contrast enhance to better view objects in the middle subwindow. A user can create composites and add colors to objects to better view objects with the image color button 1309. To classify or unclassify an object in the middle window, using an input device such as a mouse, a user can right-click an image of an object or multiple images of objects and choose Move to Class command in order to add them to a given class, or choose Exclude command to remove objects from a given class to which they were assigned.

A user may desire to create more or different clusters of objects in the population shown in the object map. In which case, a user can click the Cluster button 1306 to create new clusters based on the existing truth objects in each class.

With ground truth images and objects defined by a user into one or more classes, the AI analysis software can try to predict unclassified objects (cells) in the segment of population. The user can select or click the Predict button 1307 to have the AI image analysis software predict which class each cell belongs to. Typically, a minimum of 100 objects are required for each class to use the predict function of the AI image analysis software with the predict button. If there are insufficient objects in a class, a user can continue adding objects to each class until there are sufficient objects for a suitable model. Typically, having 1000 or more objects in a class creates a better model.

When each defined class has sufficient objects, a user can click the Training tab 1316 from the top header to display the Training window. In the training window, a user can click a train button. The AI image analysis software builds a model based on the images that have been assigned to each class. When the training model is complete, a user can click the View Results button to display the Results user interface window to evaluate the accuracy of the model.

FIG. 14A is a results user interface 1400A displaying results of the CNN image analysis displayed on a display device. The results user interface can be used to view results and generate reports from the AI image analysis device/software based on the input images and/or numeric data. Below the main tab bar and a comparison selection bar, the results user interface window includes a menu/button selection bar with ObjectID, Classifier, File, Set menu (with count view) items, and Generate Report and Update DAFs buttons. The comparison selection bar with a pair of comparison selection tabs is shown above the menu/button selection bar and below the main tab bar. In the comparison selection bar, a user can choose an individual results view tab or a comparison results view tab.

In the menu/button selection bar, the ObjectID menu allows a user to choose a specific object to view by their respective ObjectID from a specific file. The classifier selection pull down menu can update the results page for available classifiers. The file menu chooses a file to view results from a specific file. In the file menu, selecting a set chooses a data set to view the results of a model. Selecting No Truth in the file menu-selects all images included in the unknown population. Selecting Truth selects all images included in the truth populations. Selecting Truth Excluded from Training selects all images from the truth population that were excluded from the training data set. Selecting Training selects all images that were used to perform the model training. Selecting validation-Selects all images that were used to validate the model. Selecting testing in the file menu selects all images that were used to test the model. Selecting the Update DAFs button causes all the “.daf” image files that have been loaded into the experiment to be updated from the database. Selecting the Generate Report-Generates a PDF report for the experiment and opens a create PDF report popup window.

Below the menu/button selection bar of the results user interface window are displayed subwindows for Class Distribution 1406, Classification Result 1407, Statistics Table 1408, displayed objects (multispectral images of cells) subwindows each with a Prediction Probability 1409. Above the displayed objects, is a display setting bar with zoom in/zoom out buttons, an image size slider, a display setting pull down menu, a classify button, window setup button, and a sort by pull down menu 1410.

The Class Distribution subwindow 1406 displays the percentage of true and predicted events for each model class a user specified. The Classification Result subwindow 1407 displays a confusion matrix that shows the distribution of the classified images with respect to the truth populations. In a classification experiment where no truth populations have been classification provided, the matrix displays the median probability of each class. Clicking on any value in the confusion matrix to display the associated images in the image gallery. The Statistics Table subwindow 1408 displays several statistics that provide information on the classification efficiency of the model, such as precision, recall, and the F1 score (a measure of the accuracy of the model). The statistics as and the F1 score (a of the of the table also displays the number of truth events used to build the model and the total number of events classified in the experiment. In a classification experiment, the statistics table only provides the total classified classification count of images that that have been assigned to each class. The Prediction Probability subwindow 1409 displays the probability that that the object is a member of the indicated class. The prediction probability estimates how certain the model is that that the event belongs in that that class. Low probability values suggest the model is less certain about that particular object. The sorts pull down menu 1410 allows a user to sort by Experiment ID, Random or Probability. Buttons next to the sort pull down menu allow a user to the selected the sort be in an ascending or descending order.

The results tab and associated results window 1400A of the AI GUI allows a user to validate the model used to generate the results. A user can review the report results. Generally, the model is accurate when the All predicted probability in the Confusion Matrix and the F1 Accuracy values are high for each class. Select each class and visually validate that that the displayed images are truly members of that class. If they are not, click the Tagging tab at the top of the screen and add more objects to the truth population to train a new model. Click the Update DAFs button to save each cell in the truth population back to the AI imagining analysis software and feature extraction software.

If a user wants to classify objects in new files according to the model, the user can click the classify tab to open a classify window. In the classify window the user can click on classify button and classify objects in the new files according to the model. The results of the manual classifying can be reviewed by clicking on a results button that brings up the results classification UI window that looks nearly identical to the results interface for a training experiment, and allows the user to evaluate the results of the model by applying it to experimental data. Similar information is provided by the results window 1400. Under the File drop-down menu, a user can choose each data file to see the percent of objects in each class for each sample. The user can then click Update DAFs button to save each class as a new population for the software to evaluate. The software can create publication figures with representative images from each class. A user can select Generate Report button to create a PDF file and .csv files showing each of the figures in the Results interface. The .csv files contain the raw data that can be used to generate the tables and more plots using the data.

FIG. 14B is a results user interface 1400B displayed on a display device showing results of the random forest algorithm image analysis. The results user interface can be used to view results and generate reports from the AI image analysis device/software based on the input images and numeric data input. The menu/button bar contextually changed to classifiers pull down, and object ID. In a statistics subwindow on the left, a population pull down menu and a data Set pull down menu is provided. The image control bar in the middle object subwindow is similar. In a right side of the results user interface window, an object subwindow and and a recent activity subwindow are provided.

In the statistics subwindow on the left, a comparison graph is displayed showing precision, recall and F1 for each available classifier. In the middle object subwindow, object information is displayed that shows the experiment ID number and predicted class for each classifier with each image. In this case the random forest classifier and the CNN classifier are available. In this example 3 of the 4 objects (multispectral images of cells) are predicted by each classifier to be the same. However, 1 of the 4 objects had a disagreement between the two classifiers. In this case, the CNN classifier classify the cell as being in the irregular class or classification and the random forest classifier classified the call as being in the BNC class or classification. In the right side, an object details subwindow is provided that shows the prediction probability and predicted class for each classifier in a table.

FIG. 14C illustrates the create PDF report popup window that can be used generate a pdf file to printout a report from the results GUI window 1400. A user can Click the Browse button and navigate to a folder where to save the reports and click the OK button. If suffix names are desired, a user can optionally enter a suffix in the Suffix field to add the suffix to the end of the default file names. The resolution of the images of charts and graphs is selectable. Optionally, a user can select the Hi-Res images check box and save high resolution versions of the bar charts and the confusion matrix. A user can select the resolution of images to be between 200 and 1200 dots per inch. A user can specify the resolution for images using the text field next to the Hi-Res images check box. There is a global report generated for the entire population of the experiment. However, a user can optionally select to Create report a by setting a check box adjacent “Create report for each set” to create a specific report for each input .daf file in the experiment in addition to a global report. With the check box cleared, only the global report is generated. Both global and individual reports contain the information described in the Components of the PDF Report section.

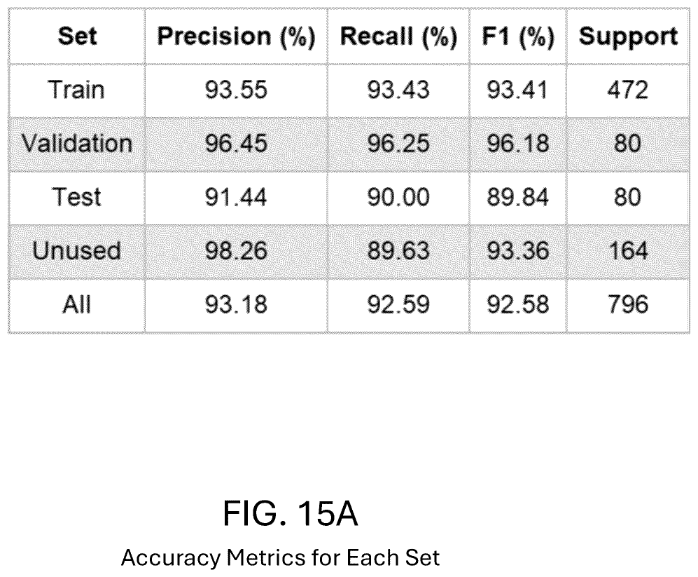

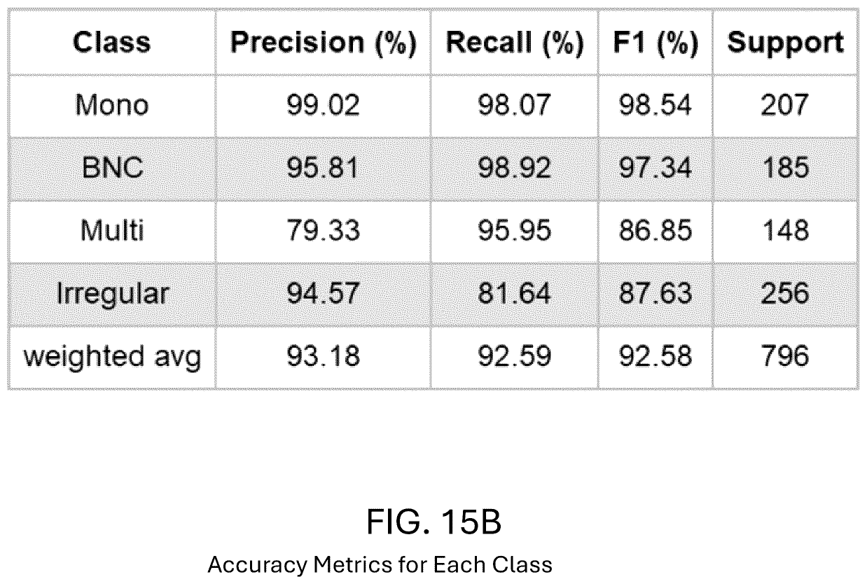

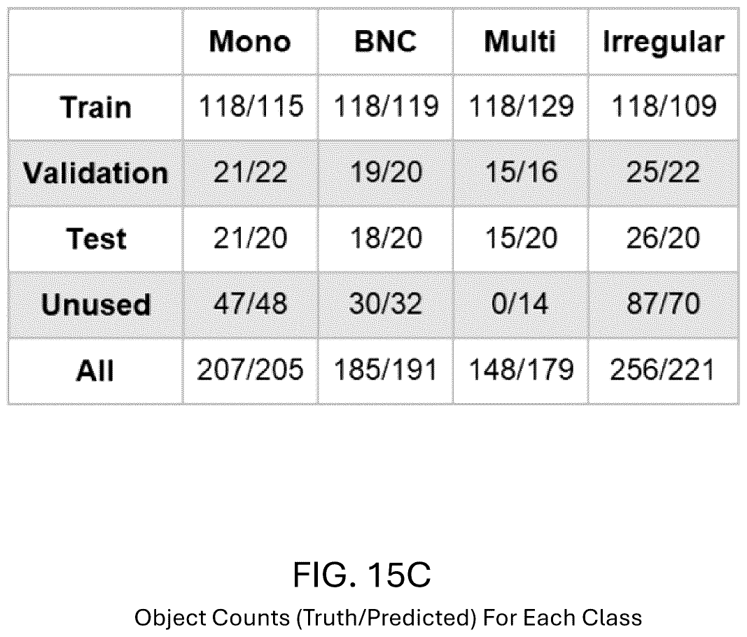

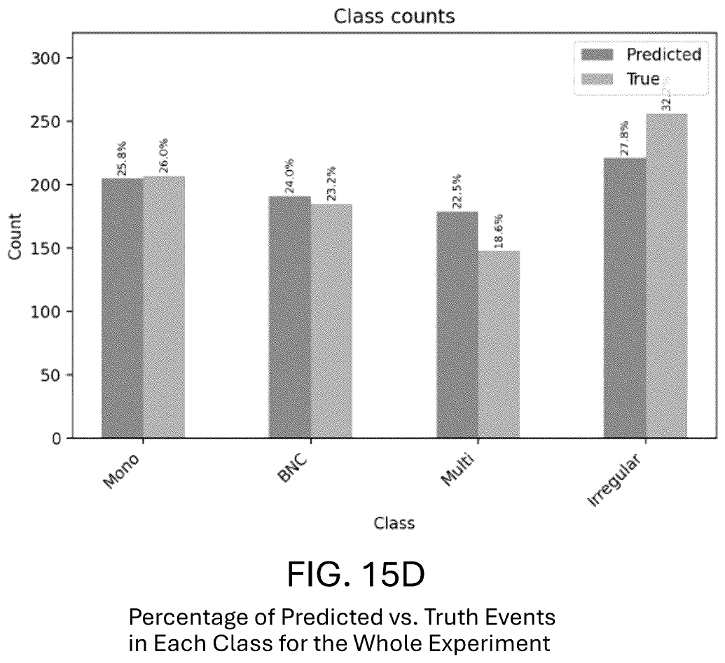

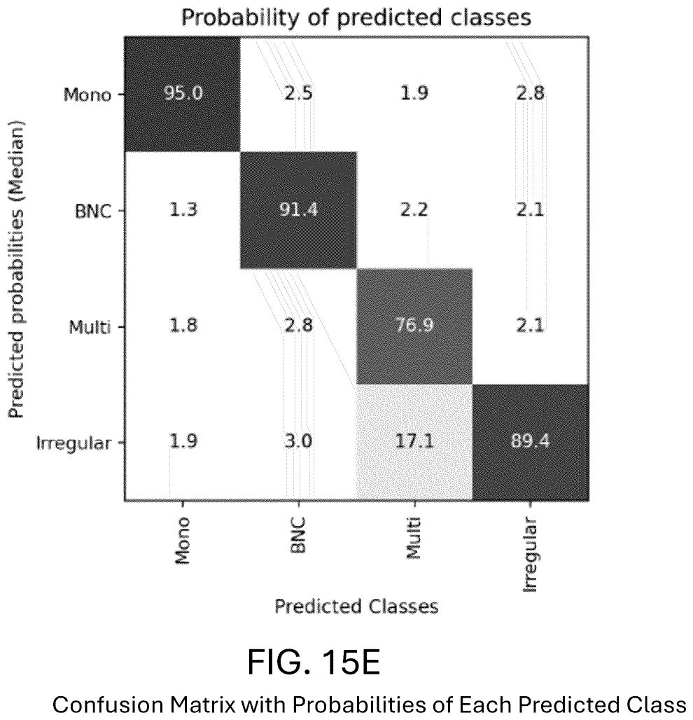

When a report is generated from the Results tab a PDF report can be created. The PDF report contains model and experiment information. The PDF report further includes charts and graphs shown in FIGS. 15A-15E indicating results of the analysis using the model and its accuracy.

FIGS. 15A-15E show exemplary charts of information that can be included in a generated report from an example training set. FIG. 15A shows a chart of accuracy metrics for each set of data, the training set of data, the validation set of data, the test set of data, and unused data. The last row combines the results for all sets. Each set is evaluated for precision percentage, recall percentage, F1 percentage, and support.

FIG. 15B shows a chart of accuracy metrics for each class. In this exemplary case, the defined classes are Mono, BNC, Multi, and Irregular. The last row is a weighted average of each class to show the overall effectiveness of the model. Each class is evaluated for precision percentage, recall percentage, F1 percentage, and support.

FIG. 15C shows a chart of object counts (truth/predicted) for each class (Mono, BNC, Multi, and Irregular) over the sets of data, the training set of data, the validation set of data, the test set of data, and unused data. The last row combines the results for all sets of data.

FIG. 15D shows a graph of percentage of predicted vs. truth events in each class for the whole experiment. The predicted bars for each class are indicated on the left bar of the pair of bars while the true bars for each class are indicated by the right bar of the pairs. The percentage is indicated at the end of bars. Each class is identified along the X axis. The Y axis indicates the count in each class.

FIG. 15E shows a confusion matrix with probabilities of each predicted class. Ideally, the diagonal should be 100 percent but there are mispredictions resulting from confusion with other classes so the numbers in the diagonal are not 100 percent.

### SUMMARY

The AI imaging software and its algorithms can analyze imaging flow cytometry data from imaging flow cytometers. The imaging flow cytometers collected bright field, side scatter, and one or more (e.g., 1 to 10) colors of fluorescence light simultaneously and at high throughput, allowing users to collect tens of thousands of images of biological cells.

A user can use statistical image analysis software to effectively mine an image database and discover unique populations based not only on fluorescence intensity but the morphology of that fluorescence as well. Feature extraction software used masking and feature calculation to perform image analysis as well. However, to accommodate increasing complexity and need for automation of image-based experiments, new AI approaches to doing data analysis are provided.

The machine learning module in the feature extraction software also allows a user to create dot plots and histograms, create statistics tables, and customize the display to view the cells as single colors or any combination of overlaid images of the user needs. The feature extraction software integrates seamlessly with the AI imaging analysis software. The feature extraction software houses the machine learning module for feature extraction and allows users to generate publication quality reports. The machine learning module also allows the user to hand tag two or more populations and then create a customized feature optimized to increase the separation of the negative and positive control samples for the user's individual experiment. It works by creating and combining the best features available in feature extraction software using a modified linear discriminant analysis algorithm to create a super feature that is specifically tailored to the user's experimental goals.

The feature extraction device/software and the AI analysis device software 107 can each be provided online through servers or as standalone software packages executed by local computers. The AI analysis device software 107 allows users to leverage the power of artificial intelligence to analyze their image data. The software will also generate a model by deep learning using convolutional neural networks to classify all user-defined populations in a sample. It includes computer aided hand tagging clustering in object map plots and creates a confusion matrix and accuracy analytics to determine how effective the model is at predicting future test samples. A comprehensive suite of image analysis software is provided including tools using artificial intelligence to simplify and strengthen the analysis of a user's image-based experiments.

### Computer Support

FIG. 1B illustrates a computer network or similar digital processing environment 10 in which the AI imaging flow cytometer system 100 can be implemented. Client computer(s)/devices 50 and server computer(s) 60 provide processing, storage, and input/output devices executing application programs and the like to implement the functionality of the feature extraction device/software 106, the AI imaging analysis device/software 107, and the database 108. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, a cloud computing environment, Local area or Wide area networks, and gateways that currently use respective protocols (TCP/IP, Bluetooth, etc.) to communicate with one another. Other electronic device/computer network architectures, such as an internet of things, and the like are suitable.

FIG. 1C is a diagram of the internal structure of a computer (e.g., client processor/device 50 or server computers 60) in the computer system of FIG. 1B. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, source feed or access to acquired images 111, displays, monitors, printers, speakers, etc.) to the computer 50, 60. Network interface 86 allows the computer to connect to various other devices attached to a network (e.g., network 70 of FIG. 4). Memory 90 provides volatile storage for computer software instructions 92 and data 94 used to implement disclosed embodiments (e.g., the feature extraction device/software 106 and the AI imaging analysis device/software 107, database 108 detailed above). Disk storage 95 provides non-volatile storage for computer software instructions 92 and data 94 used to implement the disclosed embodiments. Central processor unit 84 is also attached to system bus 79 and provides for the execution of computer instructions 92 to perform the functions of the feature extraction device/software 106 and the AI imaging analysis device/software 107 illustrated in FIG. 1A.

The flow of data and processor 84 control is provided for purposes of illustration and not limitation. It is understood that processing may be in parallel, distributed across multiple processors, in different order than shown or otherwise programmed to operate in accordance with the principles of the disclosed embodiments.

In one embodiment, the processor routines 92 and data 94 are a computer program product (generally referenced 92), stored in a computer readable medium (e.g., a removable storage medium such as one or more DVD-ROM's, CD-ROM's, diskettes, tapes, etc.) that provides at least a portion of the software instructions for the system. Computer program product 92 can be installed by any suitable software installation procedure, as is well known in the art. In another embodiment, at least a portion of the software instructions may also be downloaded by communication protocols using a wired cable connection and/or wireless connection over a computer network.

Exemplary embodiments are thus described. While certain exemplary embodiments have been described and shown in the accompanying drawings, it is to be understood that such embodiments are merely illustrative of and not restrictive on the disclosed embodiments, and that the disclosed embodiments are not limited to the specific constructions and arrangements shown and described, since various other modifications may occur to those ordinarily skilled in the art. Rather, the embodiments should be construed according to the claims that follow below.

What is claimed is:

1. A method for creating image flow cytometry experiments for artificial intelligence image analysis for multispectral cellular images acquired by an imaging flow cytometer, as shown in the figures and described in the detailed description.

2. A method for artificial intelligence image analysis, comprising:
with a user interface wizard displayed on a display device,
walking a user through setting up a training experiment in a training mode to train a new model for a desired experiment type on biological cells in a sample; and
running a classification experiment in a classification mode to classify cells by cell type and cell morphology with new high resolution multispectral cellular image data.

3. The method of claim 2, further comprising:
running a plurality of differing biological cells in a biological sample in a stream of fluid through an imaging flow cytometer to capture the new high resolution multispectral cellular image data for the plurality of differing biological cells.
